(19) United States
(12) Patent Application Publication
(10) Pub. No.: US 2015/0329316 A1
(43) Pub. Date: Nov. 19, 2015

(54) SMART ELEVATOR CONTROL DEVICE

(71) Applicant: Wen-Sung Lee, Taichung City (TW)

(72) Inventor: Wen-Sung Lee, Taichung City (TW)

(21) Appl. No.: 14/275,888

(22) Filed: May 13, 2014

(51) Int. Cl. B66B 1/24; B66B 1/34

(52) U.S. Cl. CPC B66B 1/2408; B66B 1/3415; B66B 1/3476

(57) ABSTRACT

A smart elevator control device of this invention is disclosed, comprising: a sensor, mounting aside by the elevator door to sense the number of passengers waiting for the elevator; a central control system, controlling the rise and fall of the elevators. The central control system further comprises a storage and record unit and a setting unit, where the storage and record unit records and stores the number of passengers at every floor at every moment while the setting unit is to adjust the number of passengers waiting for the elevator sensed by said sensor and to set the number of elevators to operate. By means of the central control system and accompanying sensor to sense the number of passengers waiting for the elevator, an elevator is dispatched to the desired floor to carry the passengers, to shorten the waiting time.

### BACKGROUND OF THE INVENTION

1. Field of the Invention

The present invention relates to smart elevator control devices, and more particularly to one that is able to sense the number of waiting passengers and to control the rise and fall of the elevators, which diminishes the waiting time and controls the passengers, to optimize the usage of the elevators.

2. Description of Related Art

Elevators are primary means to shuttle passengers among floors of modern high-rises. Due to its nature of up and down straight move, the elevator is not only faster than stepping through tradition stairways, but substantially diminishing the time and energy back and forth between respective floors. Be it loaded with passengers or goods, the elevator is surely indispensible equipment of modern buildings. However, by a glimpse at the elevators on the market, the majority of operation patterns of the elevators are as follows: once there are passengers in a certain floor to press the floor button to request an elevator, the whole elevators are activated to move to that floor. All of a sudden a press on the floor button at another floor, the very elevator responded by the first request will move to the floor of the later request once it finishes the delivery of the first request to its destination floor. Therefore, the passengers of the next request would wait too long. Besides, all the other elevators will not move up or down to the floor of the next request, which leads to considerable waste on the usage of all the other elevators. Accordingly, the relating manufacturers introduce a different type of elevators which improves the drawbacks of the aforementioned prior elevators.

A prior art of smart elevator is referenced herein where its elevator sensing unit is applicable to mount on top of an elevator door. The elevator sensing unit comprises an elevator controller and a sensor. The elevator controller is mounted aside by the elevator door and is provided with at least a button which is used to request an elevator. The sensor is mounted on top or vicinity of the elevator door to sense if there are passengers waiting outside of the elevator, and is electrically connected to the elevator controller, to detect if the button is pressed. Once the button of the elevator controller was pressed and no passengers waiting outside of the elevator door, the sensor will transmit a message to the elevator controller, to release the status that the button has been pressed. Accordingly, the problem of the long halt of an elevator in a certain floor can be settled, which results from the situation that the button has been pressed and the waiting passengers are gone.

On the other hand, there is another type of elevators on the market that is able to move to a desired floor without a press on the button, which is a device disposed in a hotel to guide guests to enter guest rooms. Once the guests hold an entrance card that features RFID electronic tag issued by the front counter, the information of the entrance card can be read by a RFID reader located inside or outside of the elevator and then transmitted to backend computer control system to activate the opening/closing of the elevator door. It can even activate floor indicating lights of the target floor to guide a guest into a guest room, to achieve the feature that guests enter the guest rooms free of pressing an elevator button and free of looking for the guest room with respect to the room number.

Firstly, although the aforesaid “Elevator Sensing Unit” can improve the drawback of long waiting of the passengers for the prior elevators, but the way of improvement is merely to cancel the void request at a certain floor to achieve shortening the time consuming, instead of effectively improve the problem of long waiting of passengers at the other floors. All the other elevators won't be activated to move until the elevator loaded with passengers arrives to the desired floor, which still brings about waste of time for the passengers in the other floors. Secondly, although the “Building Occupant Automatic Guiding Device” offers the direct arrival to the desired floor and avoids time consuming on waiting at another floor due to the requesting of elevator, but still fails to effectively move the elevator to pick up the waiting passengers first, which would bring about accumulation of passengers at each floor that couldn't be carried successfully by the elevator. Therefore, the related manufacturers have to think over how to improve the drawbacks brought by the prior elevators and the “Elevator Sensing Unit”.

### SUMMARY OF THE INVENTION

The primary objective of the present invention is to sense the number of passengers waiting at each floor, to dispatch elevators to the floors in need for carrying passengers, to lessen waiting time, and to improve the aforesaid shortcomings of the prior techniques and of the “Elevator Sensing Unit” and “Building Occupant Automatic Guiding Device”. Once elevators fail to effectively move to the floors with a mass of passengers for carrying, the passengers of those floors cannot help but to wait the elevator to their floors for carrying after it finishes the current delivery to its destination floor, which substantially lifts the time to wait the elevator.

Accordingly, the present invention improves the foregoing shortcomings to achieve the aforementioned objective and function. The present invention is a smart elevator control device that is used to control the rise and fall of multiple elevators, comprising: a sensor, mounting aside by the elevator door of each floor to sense the number of passengers waiting at its front; a central control system, controlling the rise and fall of the elevators, where the sensors each and the central control system are electrically connected in a wireless or wired connection. The central control system further comprises a storage and record unit and a setting unit, where the storage and record unit and the setting unit are connected in a wireless or wired connection for data transmission. The storage and record unit records and stores the number of passengers to be carried at every floor at every moment while the setting unit is to adjust the number of passengers waiting for the elevator sensed by the sensor, and to set the number of elevators to operate. By means of the setup of the built-in storage and record unit and the setting unit of the central control system and the accompanying sensor to sense the passengers waiting for the elevator, an elevator is dispatched to the required floor to carry passengers to shorten the waiting time.

A further technical feature of the present invention is that the sensor is sensitive to heat source, which is to sense the amount of heat generated by the passengers waiting at its front, and to transmit the sensed data to the storage and record unit of the central control system, where the storage and record unit further transmits the data to the setting unit to activate the elevator to move for carrying the passengers.

A further technical feature of the present invention is that the sensor is sensitive to sound source, which is to sense the loudness of the waiting passengers at its front, and to transmit the sensed data to the storage and record unit of the central control system, where the storage and record unit further transmits the data to the setting unit to activate the elevator to move for carrying passengers.

A further technical feature of the present invention is that the sensor is sensitive to face recognition, which is to sense the number of the faces of the waiting passengers at its front, and to transmit the sensed data to the storage and record unit of the central control system, where the storage and record unit further transmits the data to the setting unit to activate the elevator to move for carrying passengers.

A further technical feature of the present invention is that the central control system further comprises a data inventory unit, where the data inventory unit is used to store the data recorded by the storage and record unit, and the next data fetch.

A further technical feature of the present invention is that every elevator is provided with a light controller which is electrically connected with the central control system in a wireless or wired connection, where the light controller activates the lighting by sensing passengers inside the elevator and controls the lighting to dim gradually by sensing no passengers in the elevator, and the setting unit is to adjust the luminance of the lighting inside the elevator activated by the light controller.

A further technical feature of the present invention is that the central control system further comprises a signal receiving unit, and is provided with a mobile device which is electrically connected with the signal receiving unit of the central control system in a wireless connection, where the mobile device features requesting an elevator to the desired floor to take in advance.

A further technical feature of the present invention is that the central control system further comprises an emergency receiving unit, and is provided with an emergency care button near the elevator door of each floor and inside each of the elevators, where the emergency care buttons each is electrically connected with the emergency receiving unit of the central control system in a wireless or wired connection, and the emergency receiving unit controls an elevator to move directly to the floor with an emergency, and without being influenced by other floors.

A further technical feature of the present invention is that a mechanical control assembly is mounted on top of the outside of the elevator, where the mechanical control assembly is electrically connected with the central control system in a wireless or wired connection, and a direction control button is disposed near the elevator door of each floor, where the direction control buttons are electrically connected to the mechanical control assembly and activate the mechanical control assembly to take the control of the rise and fall of the elevator.

To summarize the aforementioned technical features of this invention, the advantage lies in the integration of the sensors with the central control system. Once a sensor senses excessive passengers waiting for the elevator at a certain area at its front, the central control system will automatically dispatch an elevator to that floor for carrying, which substantially lessens the waiting time. Moreover, by means of the integration of mobile devices with the central control system, a person ready to take an elevator is enabled to request the elevator to the desired floor to wait in advance, which also cuts down the waiting time. Besides, to protect personal safety of passengers or to cope with sudden emergencies, the elevator is provided with a light controller integrated with the built-in signal receiving unit of the central control system, which enables adaptive lighting for illumination once passengers enter the elevator, whereas ensures automatic putout when no passengers inside the elevator for electrical power saving. Moreover, an emergency care button is disposed in each of the elevators and aside by each of the elevator door, which assures a passenger in emergency to control the elevator move directly to the desired floor, and to avoid problems occurring and getting worse. Therefore, this invention is a creation of practicality and inventiveness, considerably worthy of promotion by the industry, and open to the public.

### BRIEF DESCRIPTION OF THE DRAWINGS

FIG. 1 is a flow chart of the present invention;

FIG. 2 is a schematic diagram of the elevator ahead of motion of the present invention;

FIG. 3 is a motion schematic diagram illustrating that the central control system of the present invention controls the elevator to move to the floor with mass of passengers;

FIG. 4 is a schematic diagram showing the heat sensing of the sensor of the present invention;

FIG. 5 is a schematic diagram showing the sound sensing of the sensor of the present invention;

FIG. 6 is a schematic diagram showing the face recognition sensing of the sensor of the present invention;

FIG. 7 is a motion schematic diagram illustrating that the mobile device of the present invention controls the elevator to move to the floor of carrying;

FIG. 8 is a three-dimensional diagram illustrating an emergency care button mounting aside by the elevator door of the present invention;

FIG. 9 is a motion schematic diagram illustrating that the light controller of the present invention controls the growing luminance of the lighting once passengers enter the elevator; and

FIG. 10 is a motion schematic diagram illustrating that the light controller of the present invention controls the dimming of the lighting when no passengers in the elevator.

### DETAILED DESCRIPTION OF THE INVENTION

To describe clearly that the present invention achieves the foregoing objective and function, which is a smart elevator control device, where its adopted techniques, means adopted and the desired function are described as follows with reference to a preferred embodiment and the accompanying drawings.

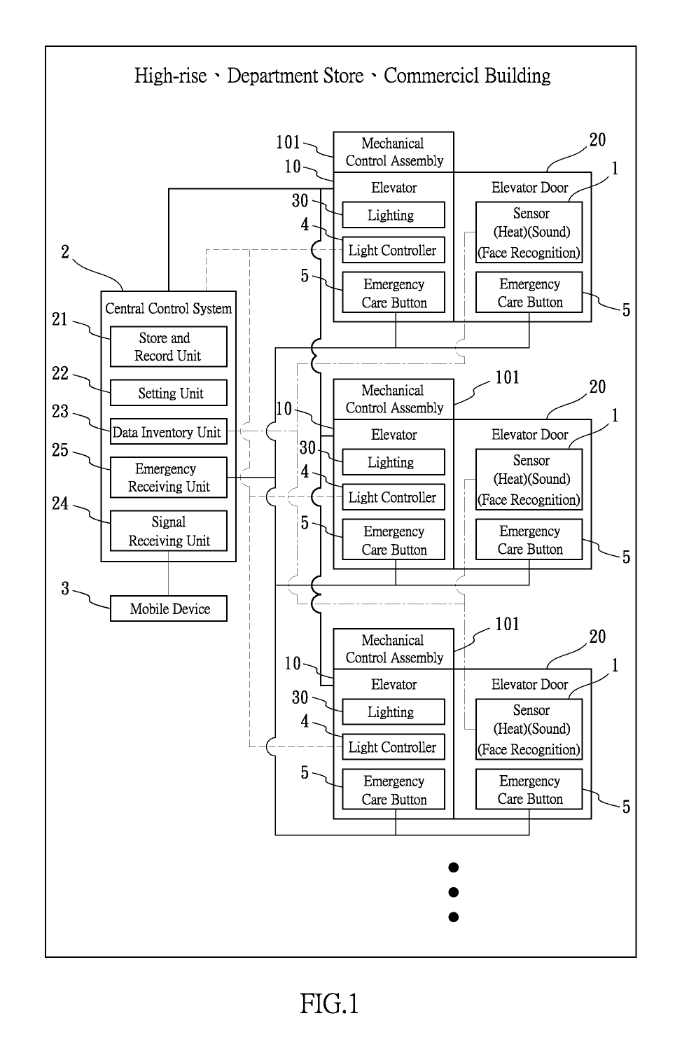

The following is described in accordance with preferred embodiments, and it is not intended to limit the form of this invention. With reference to FIGS. 1-5, a smart elevator control device of the present invention is applicable to department stores, commercial buildings and residence buildings with elevators 10, where the smart elevator control device is primarily used to control the rise and fall of multiple elevators 10, comprising: sensors 1, mounted aside by elevator door 20 of every floor (the quantity of the sensors 1 is not limited, for instance, a sensor 1 is mounted near each elevator door 20 shown in

FIG. 1). The location to mount the sensor can be on top of the center of the elevator door 20, which senses the number of passengers waiting in front of the elevator 10 in a quadrant area, however, the location to mount the sensor is not limited on top of the elevator door 20; a central control system 2, disposed in the building, primarily for the control of the rise and fall of the elevator 10, where the sensors 1 each is electrically connected to the central control system 2 respectively in a wireless or wired mode. The central control system 2 further comprises a storage and record unit 21 and a setting unit 22, where the storage and record unit 21 and the setting unit 22 are connected in a wireless or wired mode for data transmission. The storage and record unit 21 records and stores the number of passengers at every floor at every moment while the setting unit 22 is to adjust the number of passengers waiting for the elevator 10 sensed by the sensor 1, and to set the number of elevators 10 to operate. By means of the setup of the storage and record unit 21 and the setting unit 22 of the central control system 2, with the number of the passengers waiting for an elevator 10 sensed by the accompanying sensor 1, an elevator is dispatched to the required floor to carry the passengers, which would shorten the waiting time.

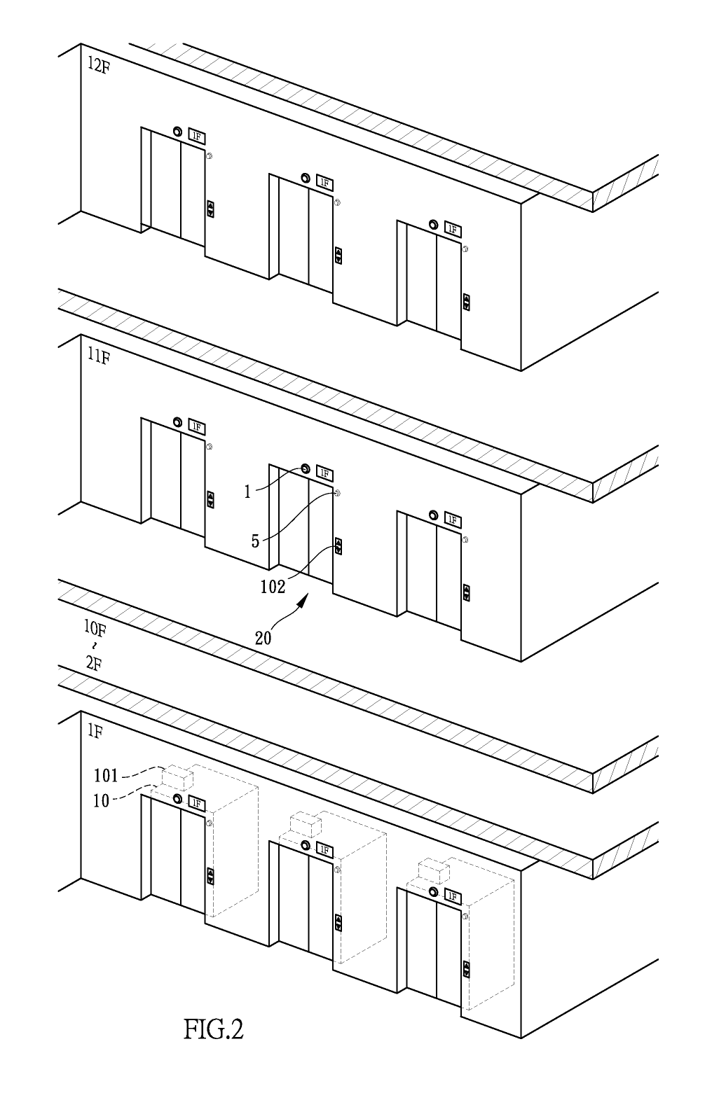

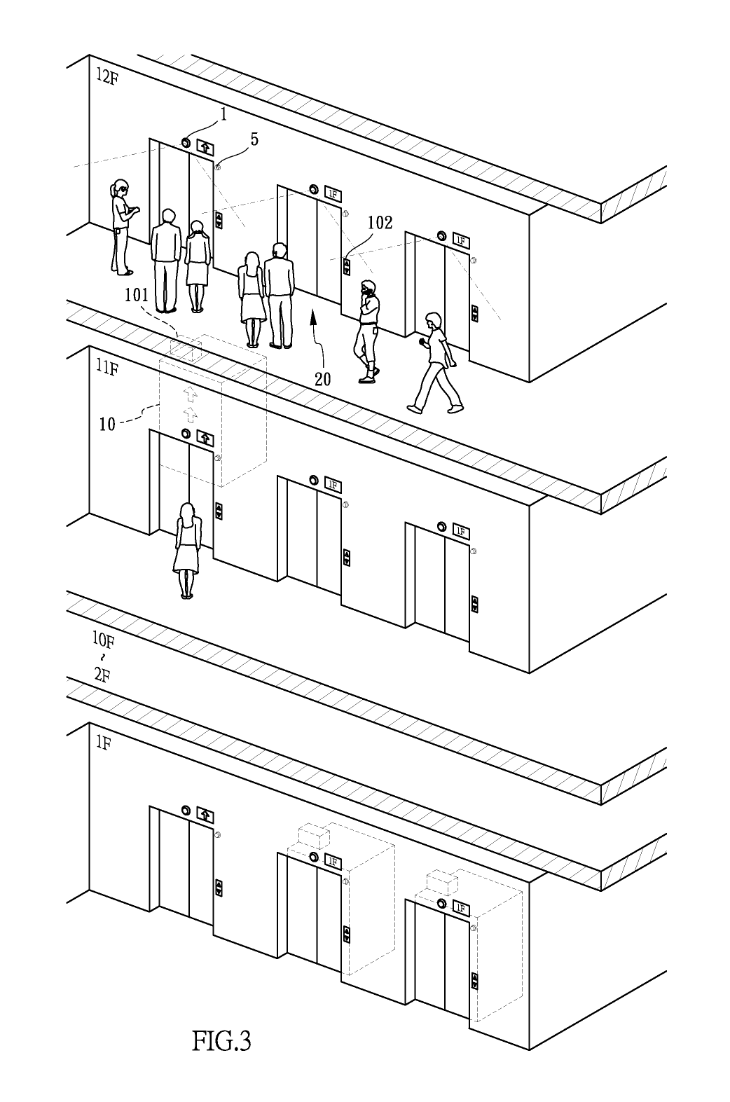

According to the foregoing description, once there are excessive passengers at a certain floor waiting for an elevator 10, which is sensed by a sensor 1 and the sensed data is transmitted to the central control system 2. By means of the storage and record unit 21 of the central control system 2 to record the number of passengers at that floor at every moment, such as at duty hour or off-duty hour, and then the central control system 2 controls to dispatch an elevator 10 to that floor for carrying passengers, which substantially lessens the time waiting for the elevator 10, carries the passengers of respectively floors effectively, and boosts the efficiency of the use of each elevator 10, to avoid the situation of empty elevator 10. Please refer to FIGS. 2-3, aside from the control of the rise and fall of the elevator 10 through the central control system 2 of the present invention, the traditional way of controlling the rise and fall of the elevator 10 by pressing an up/down button can be applied simultaneously. Therefore, a mechanical control assembly 101 is mounted on top of the outside of the elevator 10 to control the rise and fall of the elevator 10, where the mechanical control assembly 101 is electrically connected to the central control system 2 in a wired or wireless mode, and a direction control button 102 is disposed aside by the elevator door 20 of each floor, where the direction control buttons 102 each is electrically connected to the mechanical control assembly 101. Once the number of passengers waiting for an elevator 10 is less than the setting number set by the setting unit 22 of the central control system 2, the rise and fall of the elevator 10 is subject to the activation of the mechanical control assembly 101 which is controlled by pressing the direction control button 102 near the elevator door 20. And by the control of the central control system 2 and the support by the accompanying sensor 1, any passengers waiting for the elevator 10 can be prompt to take the elevator 10, which can diminish the waste of time to wait, shown in FIGS. 2-3, with a reference to FIG. 1.

The central control system 2 further comprises a data inventory unit 23, where the data inventory unit 23 is used to store the data of number of passengers at each moment at the respective floors recorded by the storage and record unit 21, and to sort and record each record of data, which facilitates the central control system 2 to dispatch an elevator 10 for carrying. And the stored data in the data inventory unit 23 are used as the reference for the next dispatch of an elevator 10 to a certain floor for carrying by the central control system 2, which avoids problems as the activation of an elevator to go at a wrong time or the failure to assign an elevator 10 at a right time, shown in FIG. 2.

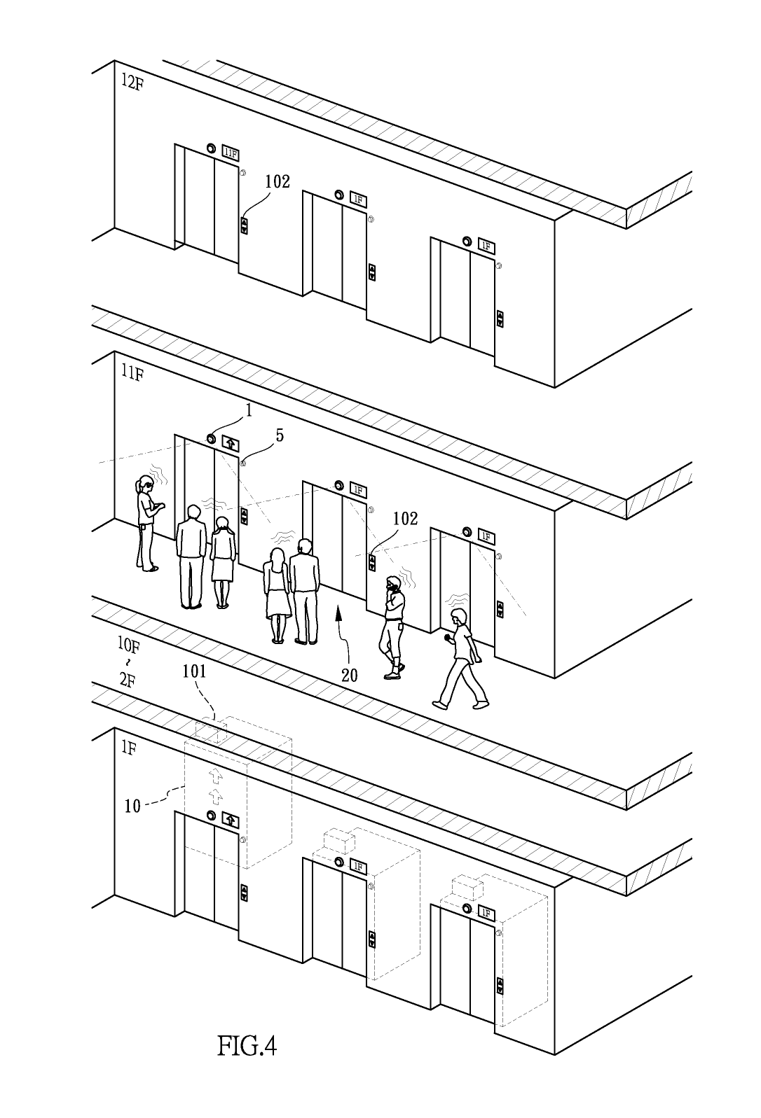

To cope with the advancement of modern science of nowadays, the design of the sensor in sensing can be sensitive to heat source, sound source and face recognition, where the portion of heat source sensing—once a mass of passengers appear in front of the elevator door 20 waiting for the elevator 10, since human body is provided with moderate heat, the sensor 1 will sense the capacity of the body heat and transmit the sensed data to the central control system 2 for identifying. With the central control system 2, the user presets a threshold value of heat through the setting unit 22 that enables the central control system 2 to take the control of the rise and fall of the elevator 10. The storage and record unit 21 records every preset parameters and corresponding number of passengers and stores in the data inventory unit 23, with which the moment the heat data is transmitted to the central control system 2, the data inventory unit 23 will analyze immediately the recorded and stored data and offer them to the central control system 2 for the dispatch of an elevator 10 to the desired floor for picking up the passengers waiting for the elevator 10, shown in FIG. 4, with a reference to FIG. 1.

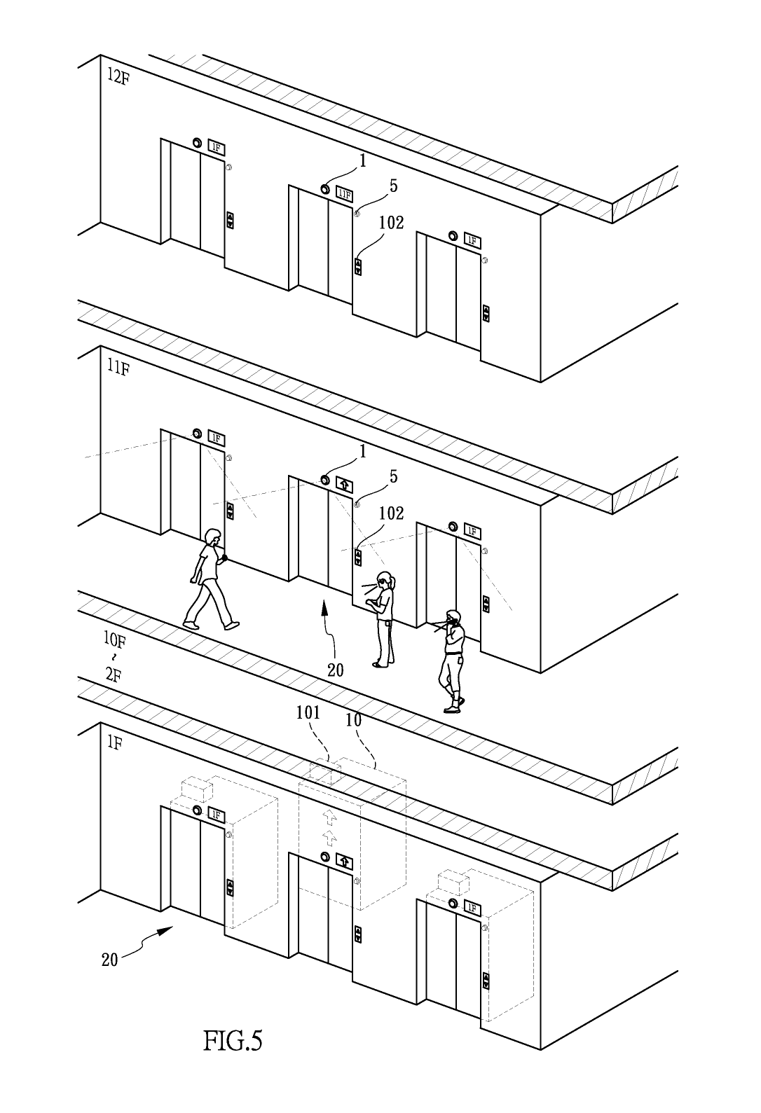

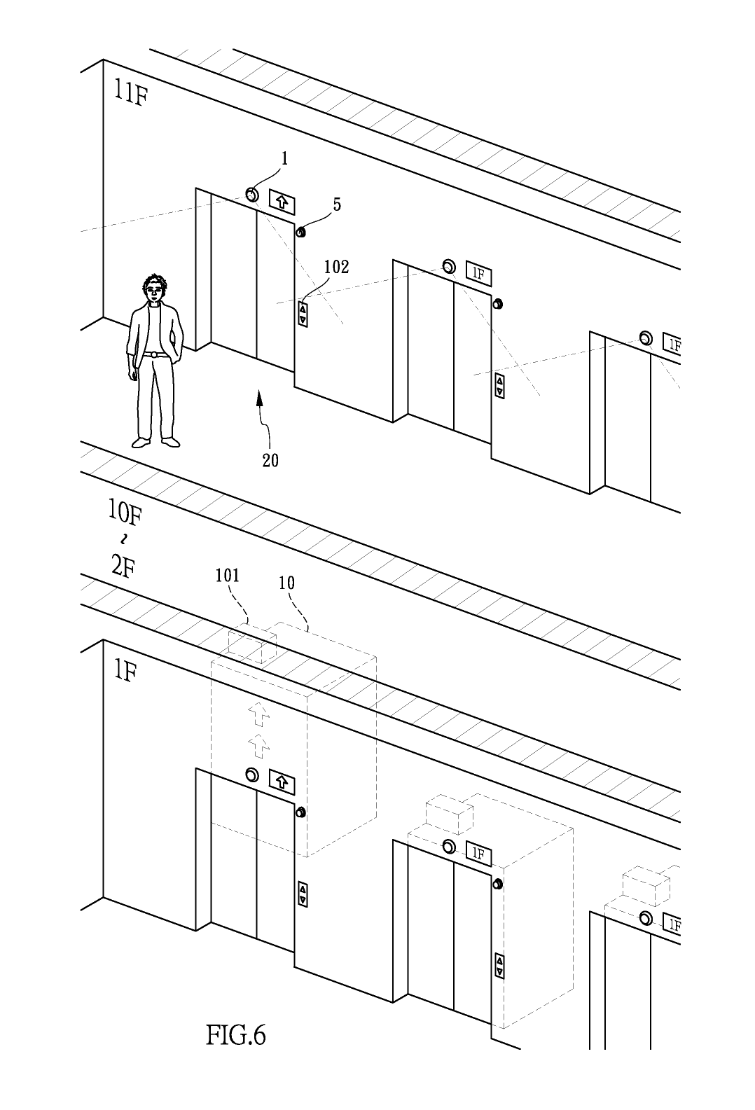

On the other hand, for the portion on sound sensing, the sensor 1 is sensitive to any sound generated by the passengers waiting in front of the elevator 10, for instance: voice, footfall and the like, to sort and integrate all kinds of sounds into acoustic signal to send to the central control system 2, and to dispatch the elevator 10 to the desired floor for carrying the passengers waiting for the elevator 10. The applications of the storage and record unit 21 and the setting unit 22 of the central control system 2 herein are identical to those on heat sensing. The volume of sound to sense can be preset by the setting unit 22, or the specific audio frequencies to sense can be preset, and the central control system 2 thus can take the control of the elevator 10 based on the preset values of the setting unit 22. The storage and record unit 21 also records the sound volume at each moment and stores in the data inventory unit 23, with which the central control system 2 can dispatch the elevator 10 to carry immediately through the sensor 1, to diminish the waiting time, shown in FIG. 5, with a reference to FIG. 1. For the last portion on the face recognition sensing, the sensor 1 is able to recognize faces of the crowd waiting in front of the elevator 10 by means of photograph and the like, and records the sensing data by the storage and record unit 21, followed by storing the recorded data in the data inventory unit 23. When the sensor 1 engages the sensing, the sensed data are compared with the relevant data in the data inventory unit 23, the number of persons waiting for the elevator 10 is figured out, with which the central control system 2 can dispatch the elevator 10 for carrying. On the other hand, the applications of the storage and record unit 21 and the setting unit 22 are identical to the previous two, which will not be reiterated herein. Please refer to FIG. 6, with a reference to FIG. 1.

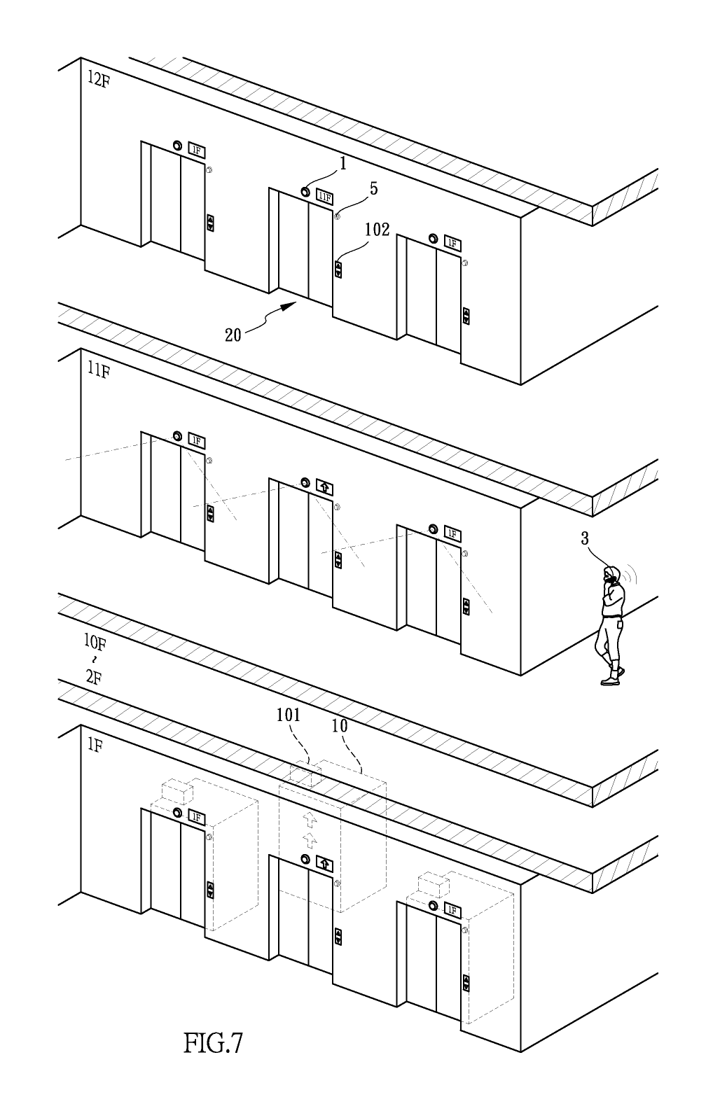

The present invention is designed to control the elevator 10 to move for carrying based on the number of persons waiting in front of the elevator 10 which diminishes the waiting time, and is further provided with a built-in signal receiving unit 24 in the central control system 2 to be connected wirelessly with a mobile device 3, for instance: everybody at each floor can be wirelessly connected to the signal receiving unit 24 of the central control system 2 by means of the mobile device 3, such as cell phone, tablet and the like. In this way one can send a message to the signal receiving unit 24 of the central control system 2 in advance when ready for off-duty, and the central control system 2 compiles the number of persons to send the message and their corresponding lead time with respect to each floor, followed by the control of the elevator 10 to the floor with more people first, and to the other floors for carrying sequentially, which substantially lessens the time waiting for the elevator 10, and maximizes the efficiency of the use of all elevators 10, shown in FIG. 7. FIG. 7 shows a cell phone which is an embodiment of the mobile device 3, which is not for limiting the type of the mobile device 3.

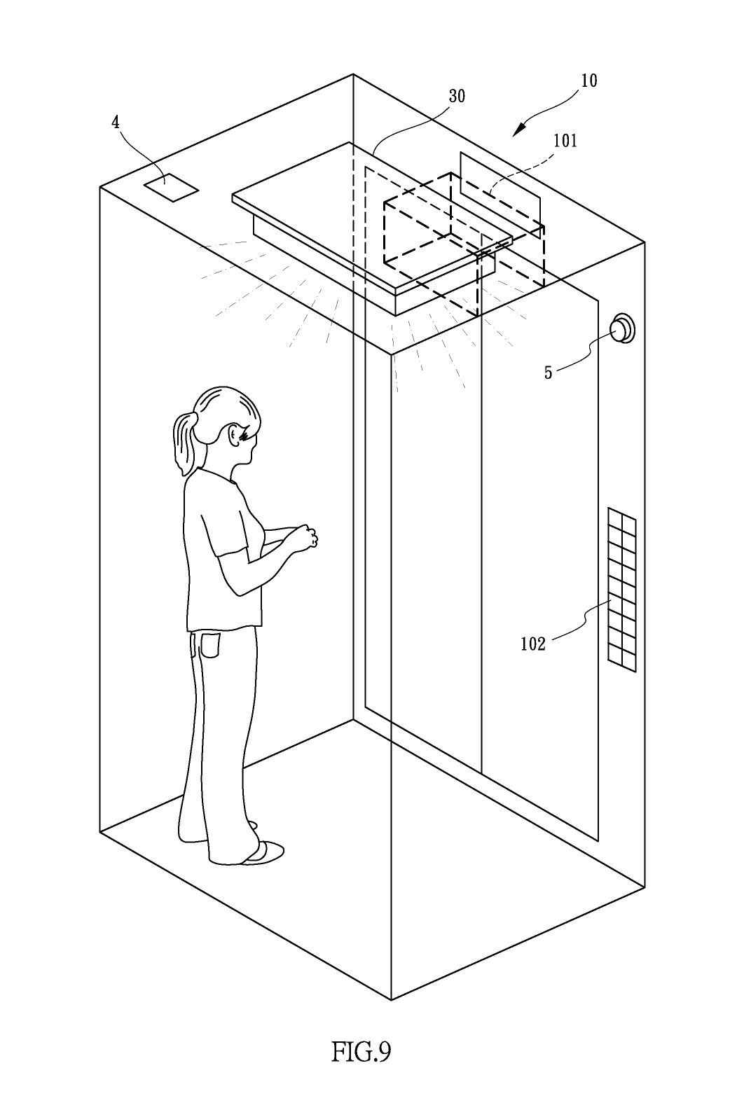

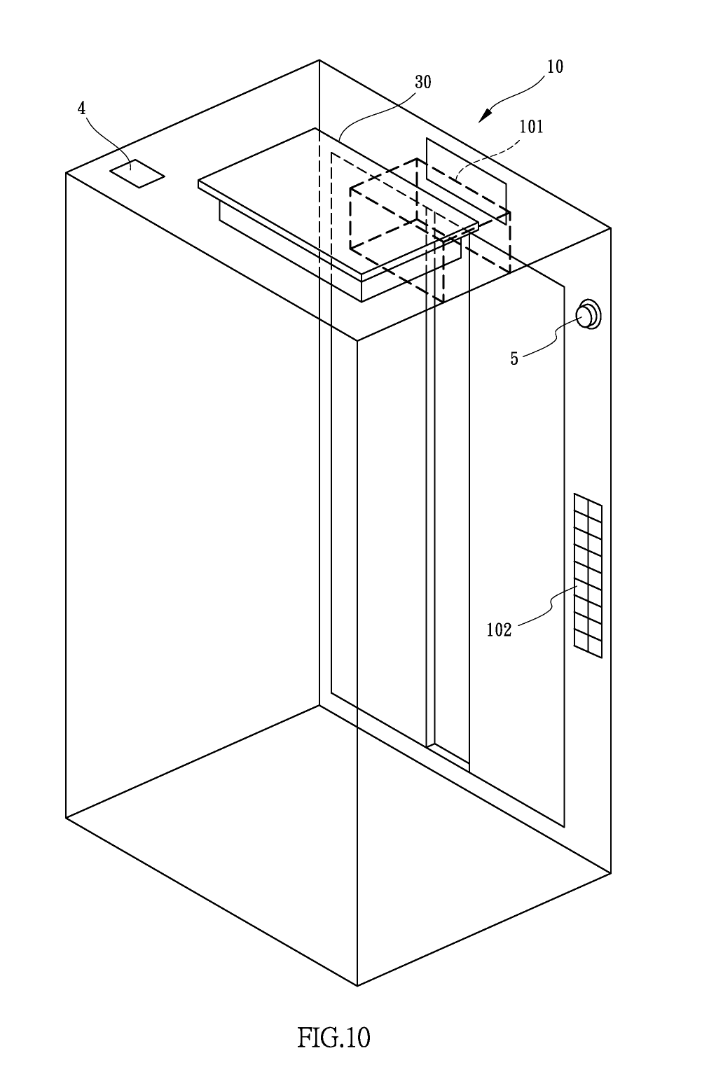

There is always lighting 30 provided for illumination in the elevator 10, which is targeted for clearly recognizing the floor to go and for protecting personal safety. On the other hand, the lighting also provides the security the monitoring and the recording. However, the lighting 30 internal to the elevator 10 is luminous day and night, which for sure brings about waste on electricity and shrinks the tenure of use of the lighting 30. Therefore, a light controller 4 is disposed on the inside of each elevator of the present invention, where the light controller 4 is electrically connected to the central control system 2 in a wired or wireless connection. Once an elevator 10 has been dispatched for carrying and the elevator door 20 is open for passengers entering, the light controller 4 will activate the lighting 30 for illumination once by sensing number of passengers inside the elevator 10. On the contrary, once the whole passengers leave the elevator 10, the light controller 4 controls the lighting 30 to dim gradually until put-out by sensing no passengers in the elevator 10, which cuts down the waste of electrical power. The setting unit 22 of the central control system 2 sets the light controller 4 which in turn controls the illumination of the lighting 30. The way of sensing of the light controller 4 can be the heat, sound, face recognition and the like, which will not be limited herein. Please refer to FIGS. 9-10, with a reference to FIG. 1.

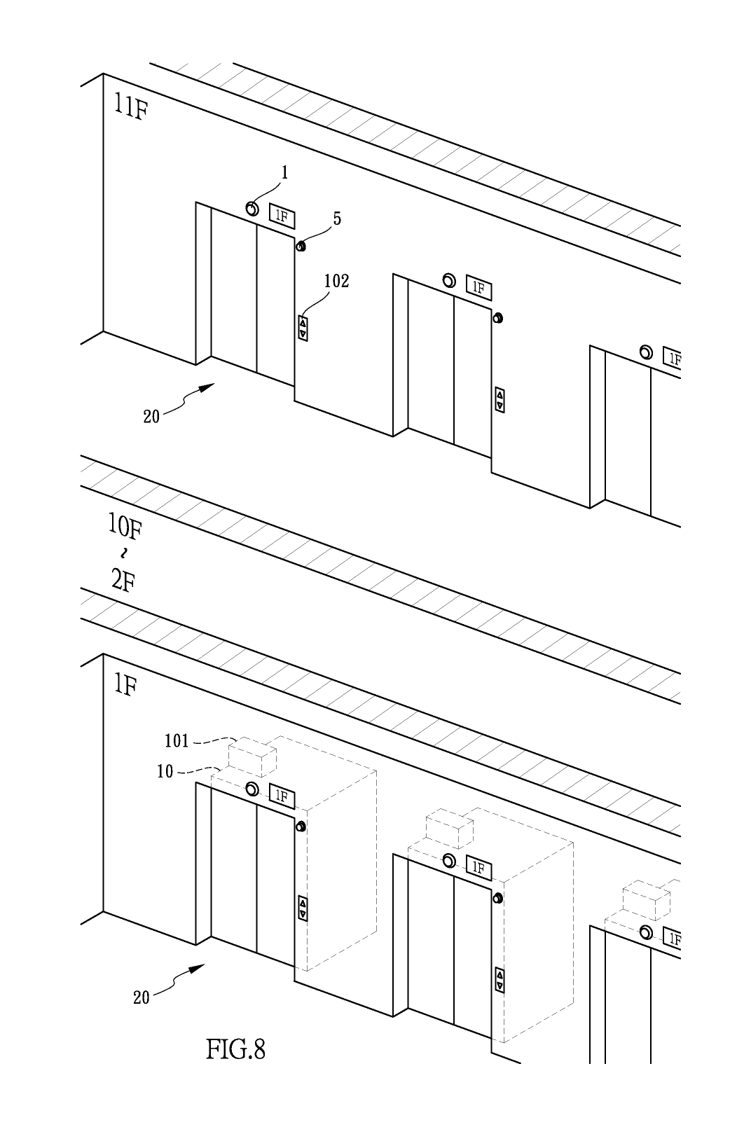

A design for the response to sudden accidents is considered in the present invention, which calls for an emergency care button 5 disposed aside by the elevator door 20 of each floor and inside each of the elevators 10 to get more time for rescue while the central control system 2 further comprises an emergency receiving unit 25, where the emergency care buttons 5 each is electrically connected with the emergency receiving unit 25 in a wireless or wired connection. Once there is an emergency at a certain floor, an emergency care button 5 near the elevator door 20 or inside an elevator 10 is pressed, and a message is sent to the emergency receiving unit 25, which further enables the central control system 2 to take the control of the elevator 10 to move to the desired floor for carrying. As the central control system 2 receives the message from the emergency receiving unit 25, it won't terminate by the influence of the other floors, which boosts the available time for the rescue. Please refer to FIGS. 8-9, with a reference to FIG. 1.

Through the integration of the sensor 1 with the central control system 2, a considerable reduction of time waiting for the elevator 10 for those people in the high-rises, department stores or commercial buildings comes true; meanwhile, each elevator 10 achieves its maximum utilization. Besides, the present invention is provided with direction control buttons 102 popular on the market, where the direction control button 102 is disposed aside by the elevator door 20 and on the inside of the elevator 10. Aside from making use of the sensing of the sensor 1 for backing the central control system 2 to control the rise and fall of the elevator 10, the direction control button 102 is also available to activate the mechanical control assembly 101 to take the control of the rise and fall of the elevator 10. However, the use of sensing is still the major way. This invention features great practicality by comparing with the prior techniques, whether it is the wait for an elevator, the use of emergency, or even the cost of electricity for the internal lighting 30 of the elevator 10, all of them have made considerable improvement. The foregoing descriptions are the exemplified embodiments of the present invention, where the scope of the claim of the present invention is not intended to be limited by the embodiments. Any equivalent embodiments or modifications without departing from the spirit and scope of the present invention are therefore intended to be embraced.

What is claimed is:

1. A smart elevator control device, to control the rise and fall of an elevator, comprising:
a sensor, mounting aside by an elevator door of each floor to sense the number of passengers waiting for the elevator at its front; and
a central control system, controlling the rise and fall of the elevators, where said sensor and said central control system are electrically connected in a wireless or wired connection, said central control system further comprising a storage and record unit and a setting unit, where the storage and record unit and the setting unit are connected in a wireless or wired connection for data transmission, the storage and record unit recording and storing the number of passengers at every floor at every moment while the setting unit is to adjust the number of passengers waiting for the elevator sensed by said sensor, and to set the number of elevators to operate;
wherein, by means of the setup of the storage and record unit and the setting unit of said central control system and accompanying sensor to sense the number of passengers waiting for the elevator, an elevator being dispatched to a certain floor to carry the passengers, to shorten the waiting time.

2. The smart elevator control device as claimed in claim 1, wherein said sensor is sensitive to heat, which is to sense heat capacity generated by the passengers waiting in front of the elevator, and to transmit the sensed data to the storage and record unit of said central control system, where the storage and record unit further transmits the data to the setting unit to activate the elevator to move for carrying the passengers.

3. The smart elevator control device as claimed in claim 1, wherein said sensor is sensitive to sound, which is to sense loudness of the passengers waiting in front of the elevator, and to transmit sensed data to the storage and record unit of said central control system, where the storage and record unit further transmits data to the setting unit to activate the elevator to move for carrying the passengers.

4. The smart elevator control device as claimed in claim 1, wherein said sensor is sensitive to face recognition, which is to sense the number of faces of the passengers waiting in front of the elevator, and to transmit sensed data to the storage and record unit of said central control system, where the storage and record unit further transmits data to the setting unit to activate the elevator to move for carrying the passengers.

5. The smart elevator control device as claimed in claim 1, wherein said central control system further comprises a data inventory unit, where the data inventory unit is used to store the data recorded by the storage and record unit, and to fetch the next data.

6. The smart elevator control device as claimed in claim 1, wherein each elevator is further provided with a light controller which is electrically connected with said central control system in a wireless or wired connection, where the light controller activates internal lighting for illumination by sensing passengers inside the elevator and controls the lighting to dim gradually by sensing no passengers inside the elevator, and the setting unit being to adjust the luminance of the internal lighting of the elevator activated by the light controller.

7. The smart elevator control device as claimed in claim 1, wherein said central control system further comprises a signal receiving unit and is provided with a mobile device which is electrically connected with the signal receiving unit of said central control system in a wireless connection, where the mobile device features requesting an elevator to the floor to take in advance.

8. The smart elevator control device as claimed in claim 1, wherein said central control system further comprises an emergency receiving unit and is provided with an emergency care button disposed aside by the elevator door of each floor and inside each of the elevators, where the emergency care buttons each is electrically connected with the emergency receiving unit of said central control system in a wireless or wired connection, and the emergency receiving unit controlling an elevator to move directly to the floor with an emergency, without influence by other floors.

9. The smart elevator control device as claimed in claim 1, wherein a mechanical control assembly is further mounted on top of the outside of the elevator, where the mechanical control assembly is electrically connected with said central control system in a wireless or wired connection, and a direction control button being disposed aside by the elevator door of each floor, where the direction control buttons each is electrically connected to the mechanical control assembly and activates the mechanical control assembly to take the control of the rise and fall of the elevator.
